(19) United States
(12) Patent Application Publication
(10) Pub. No.: US 2010/0027599 A1
(43) Pub. Date: Feb. 4, 2010

(54) Power Line Communications Adapter

(76) Inventors: Anthony Di Chiro, Chatsworth, CA (US); Demian Martin, San Leandro, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/183,004

(22) Filed: Jul. 30, 2008

(51) Int. Cl. H04B 1/38

(52) U.S. Cl. 375/222

(57) ABSTRACT

A power line communications (PLC) adapter for connecting to a standard wall outlet and providing power to other electrical devices and connectivity to the PLC network. The adapter includes a PLC modem and a noise isolating filter which prevents high frequency noise from an attached electrical device from affecting the PLC modem and the PLC network.

### TECHNICAL FIELD

The present invention relates to the field of networks. More specifically, the present invention relates to power line communications networks.

### BACKGROUND ART

Nearly all buildings possess a plurality of alternating current (AC) electrical outlets for providing power to various electrical devices. The electrical wiring for these outlets forms a network that couples the outlets to each other. This network of power lines may be utilized for the transmission of data from one outlet to another.

A power line communications (PLC) network is formed by connecting a plurality of PLC modems to various electrical outlets in a building to facilitate transmission and reception of data over the power line network. A PLC modem is generally a device which encodes and transmits data over a PLC network, and also receives and decodes such transmissions. PLC networks typically operate in the frequency range of 2 to 30 Megahertz. Thus, in a simple PLC network setup, a first device (such as a computer or audio/video or communications device) connects to a first PLC modem, which in turn is connected to an AC outlet in one room. In a second room, a second device connects to a second PLC modem, which in turn is connected to a second AC outlet. The first and second devices transmit and receive data via their respective PLC modems, which serve as interfaces for the PLC network that operates over the power lines which connect the outlets in the different rooms.

Because PLC networks operate in a high frequency range, they are susceptible to high frequency noise from other devices or appliances which are connected to the power lines. Devices that are especially likely to produce such noise include the following: hairdryers, blenders, massage chairs, paper shredders, tread mills, halogen lamps, cell phone chargers, electric power drills, LCD televisions, devices having electric motors, etc. Noise contamination on a PLC network results in lower data bandwidths, which limits the network's utility to the end user.

It is therefore desirable to interpose a filter between such noise-producing devices and the outlets to which they connect in order to prevent the introduction of noise onto the power line which may degrade the PLC network quality. However, such a filter could not be interposed between a PLC modem and an outlet because the filter would eliminate the high frequency data, as it would be considered as noise.

Oftentimes, it is necessary due to a scarcity of outlets in a desirable location to connect both a PLC modem and several additional devices to the same outlet. Therefore, there is a need for an integrated device which provides a filter to prevent the introduction of unwanted noise onto the power lines, and a PLC modem for the transmission and reception of data over a power line network.

### DISCLOSURE OF THE INVENTION

Accordingly, the present invention provides a PLC adapter for use in a PLC network. In one embodiment of the invention, the adapter includes an input power plug for connecting to an AC outlet, and an output power plug for connection to other electrical appliances. The PLC adapter contains a PLC modem for encoding and decoding data that is transmitted over the PLC network. Furthermore, the PLC adapter contains noise isolating filters which prevent high frequency noise that is generated by an attached appliance from entering the PLC network. These noise isolating filters also prevent high frequency noise from traveling from the PLC network to the attached appliance.

An alternative embodiment of the invention is similarly presented but without a PLC modem. This embodiment is useful where one does not require a PLC modem, but nonetheless wishes to prevent noise from an electrical appliance from entering and contaminating a PLC network.

By interposing the adapters of the present invention between noise-generating appliances and the PLC network, a cleaner PLC network is achieved that is capable of transmission of higher data bandwidths. This increase in data bandwidth improves the functionality of the PLC network, and may be especially useful for bandwidth intensive applications, such as streaming high definition video material.

In order to achieve the highest possible bandwidths on a PLC network, one may attach the adapters of the present invention at each outlet in a PLC network. This would maximize the isolation of the PLC network from contaminating noise.

### BRIEF DESCRIPTION OF THE DRAWINGS

For a better understanding of the present invention, reference is made to the below-referenced accompanying drawings. Reference numbers refer to the same or equivalent parts of the present invention throughout the several figures of the drawings.

FIG. 1 is a perspective view of a power line communications adapter in accordance with an embodiment of the present invention.

FIG. 2 is an alternative perspective view of a power line communications adapter in accordance with an embodiment of the present invention.

FIG. 3 is a schematic diagram showing details of the circuitry of a power line communications adapter in accordance with an embodiment of the invention.

### BEST MODES FOR CARRYING OUT THE INVENTION

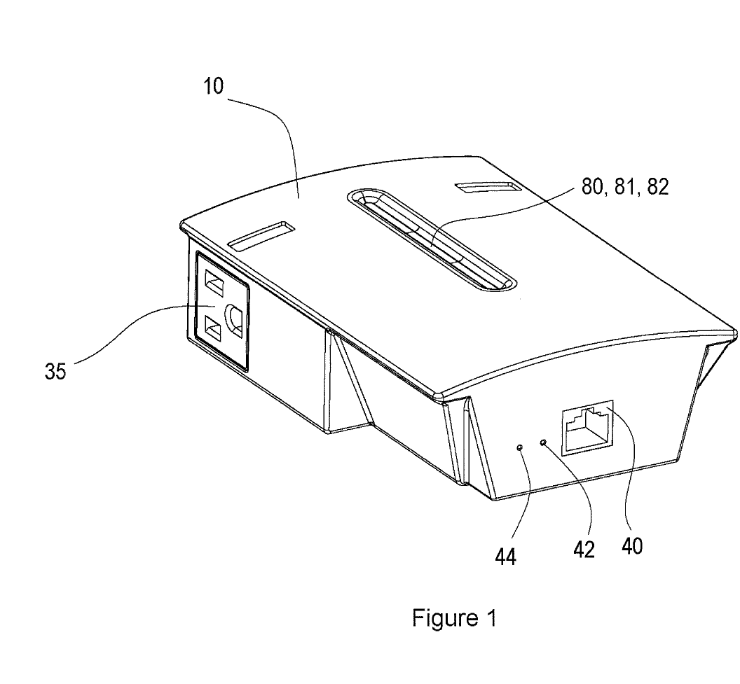

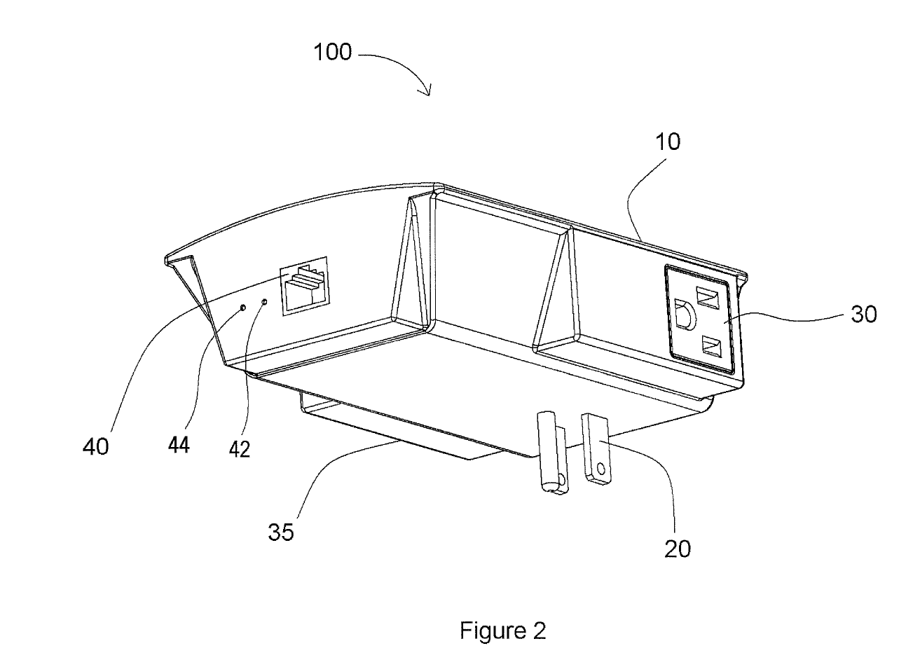

FIGS. 1 and 2 illustrate in alternative perspective views an integrated power line communications (“PLC”) adapter 100 for use in a PLC network, in accordance with an embodiment of the present invention. A housing 10 provides protection for the components and circuitry of the adapter 100, which are herein described in further detail. Input power plug 20 connects to a standard AC outlet in a building having multiple outlets which are electrically coupled to each other. The input power plug 20 is preferably a standard three-prong male AC plug. Output power plugs 30 and 35 provide power to external electrical devices or appliances, and are preferably formed as standard three-prong female AC outlets. Modem data port 40 connects to devices that receive and/or transmit data over the power line network. The modem data port 40 in the embodiment of the invention as shown is a CAT5 connector. In other embodiments of the invention, the modem data port 40 may be other connector types.

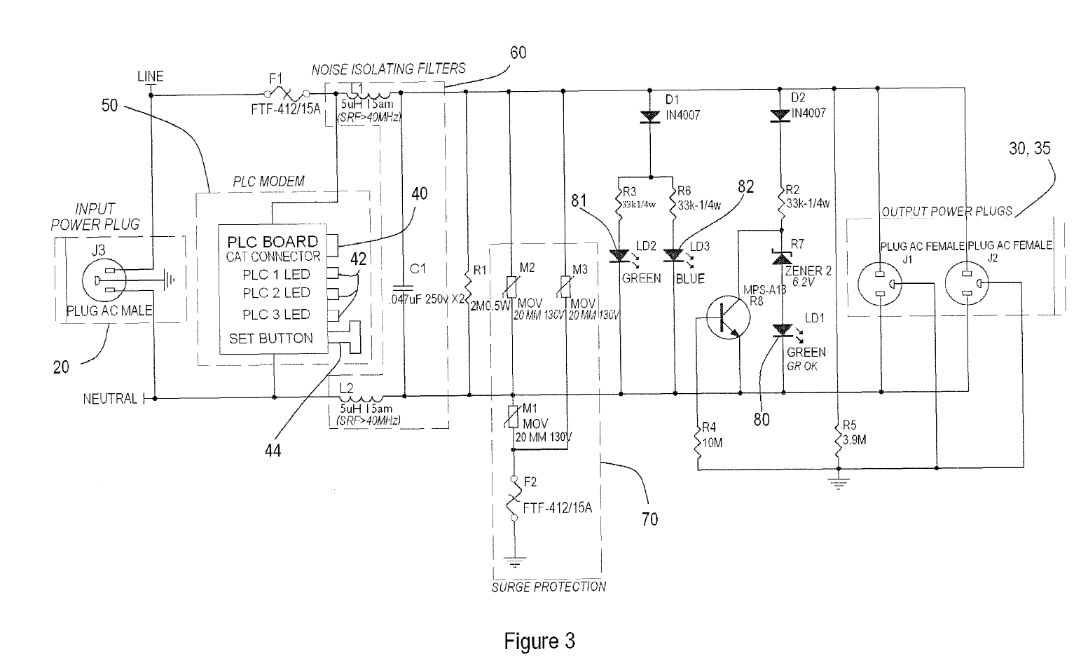

FIG. 3 is a schematic diagram showing the internal components and circuitry of the adapter 100.

PLC modem 50 processes and encodes data for transmission over the PLC network, and likewise receives and decodes data from the PLC network. In a preferred embodiment of the invention, PLC modem 50 facilitates the operation of a TCP/IP network, as is customarily useful for modern home networking applications. In other embodiments of the invention, PLC modem 50 may facilitate other types of networks and protocols, such as for streaming audio or video content. LEDs 42 indicate the status of various parameters relating to the PLC network and PLC modem 50, such as the following: power, security, connectivity of the PLC network, data connectivity, data rate, and data activity. Set button 44 provides additional functionality such as resetting the PLC network, renaming the PLC network, setting security features of the PLC network, synchronization with a computer, etc.

Noise isolating filters 60 isolate the PLC modem 50 from high frequency noise from devices which are connected to the output power plugs 30 and 35, and furthermore prevent the introduction of such noise onto the PLC network. In one embodiment of the invention, the filters 60 consist of a pair of inductors coupled with a capacitor. The filters 60 are specialized to filter out noise while protecting the power line communication signal. In the preferred embodiment, the noise isolating filters 60 maintain electrical characteristics from 2 MHz to 34 MHz, these being the frequencies at which the PLC network operates. It is noted that while the filters 60 function to prevent noise from devices connected to output power plugs 30 and 35 from entering the PLC network, they also prevent noise from traveling in the opposite direction—i.e. from the PLC network to the output power plugs.

Surge protection 70 prevents damage to the adapter 100 from power surges. In one embodiment of the invention, the means for surge protection comprises a number of metal oxide varistors (MOV's).

Ground indicator LED 80 indicates that there is a proper grounding of the circuit. Indicator LEDs 81 and 82 indicate proper functioning of the power circuit. The PLC adapter 100 as presently described offers significant advantages for PLC networking. By interposing adapter 100 between an electrical device and an AC outlet, noise that would otherwise degrade the performance of a PLC network is filtered out. Moreover, the integration of the PLC modem into the device eliminates the need for a separate PLC modem and its associated electrical cord and additional clutter.

An alternative embodiment of the invention (not shown) is similar to adapter 100, but does not contain a PLC modem. Such an embodiment of the invention can be inserted between an electrical device and a power outlet, and is useful for preventing noise from the electrical device from interfering with the PLC network.

In order to prevent noise from entering a PLC network, one could apply multiple adapters of the present invention as described above throughout a building on each power outlet. In such a system, the power lines would be maximally isolated from noise and thereby achieve the highest possible data bandwidths. With higher data bandwidths, a user could enjoy faster performance, which may be especially noticeable for bandwidth-intensive applications such as streaming high-definition video content from a remote or networked source.

In an alternative embodiment of the invention, the above-described PLC adapter is adapted for in-wall use, functioning as a replacement for standard AC wall outlets. In this embodiment, the adapter does not need an input power plug, but is directly wired to the line, neutral, and ground electrical lines.

Information as herein shown and described in detail is fully capable of attaining the above-described object of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, in which reference to an element in the singular is not intended to mean “one and only one” unless explicitly so stated, but rather “one or more.”

All structural and functional equivalents to and combinations of the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. §?112, sixth paragraph, unless the element is expressly recited using the phrase “means for.”

### INDUSTRIAL APPLICABILITY

The present invention is industrially applicable to power line communications networks and their associated outlets.

1. (canceled)

2. (canceled)

3. (canceled)

4. A power-line communications adapter, for connecting electrical devices to an alternating current power outlet and for reducing noise in a power-line communication network, comprising:
a. One or more female output power plugs for providing power to plug-in electrical devices;
b. One or more noise isolating filters, for reducing noise in said power-lines, coupled to said female power output plugs;
c. A surge protector, for preventing voltage spikes from reaching said noise filters and said female power output plus, coupled to said noise isolating filters; and,
d. One or more male power input plugs, for connecting to an alternating current power outlet, coupled to said surge protector and to said noise isolating filters.

5. The power-line communications adapter of claim 4, further comprising:
a. A data port for receiving a computer communication line; and,
b. A power-line communication modem, for encoding and decoding data transmitted over a power-line communication network, interposed between and coupled to said data port and to said male power input plug(s).

6. The adapter of claim 4, further comprising one or more light indicators, for showing the status of circuit grounding or circuit voltage, coupled to said female power output plugs.

7. The adapter of claim 4, further comprising one or more light indicators for showing the condition of said noise filters, each indicator coupled to one of said noise filters.

8. The adapter of claim 4, further comprising one or more light indicators coupled to said modem, each indicator for showing a condition selected from the following: connectivity status, power status, security status, activity, network status and data rate.

9. The adapter of claim 4 wherein said noise isolating filters filter out electrical noise in the frequency range between 2 MHz and 34 MHz.

10. The adapter of claim 4 wherein said surge protectors comprise one or more metal oxide varistors.

11. A mountable power outlet, for providing connectable access to an alternating current power-line and for reducing noise in a power-line communication network, comprising:
a. One or more female output power plugs for providing power to plug-in electrical devices;
b. One or more noise isolating filters, for reducing noise said power-lines, coupled to said female power output plugs;
c. A surge protector, for preventing damage to said filters and to said electrical devices, coupled to said noise isolating filters; and,
d. A terminal, for connecting the forgoing elements to an alternating current power-line, coupled to said surge protector and to said noise isolating filters.

12. The mountable power outlet of claim 11, further comprising:
a. A data port for receiving a computer communication line; and,
b. A power-line communication modem, for encoding and decoding data transmitted over a power-line communication network, interposed between and coupled to said data port and to said terminal.

13. The outlet of claim 12, further comprising one or more light indicators coupled to said modem, each indicator for showing a condition selected from the following: connectivity status, power status, security status, activity, network status and data rate

14. The outlet of claim 11, further comprising one or more light indicators, for showing the status of circuit grounding or circuit voltage, coupled to said female power output plugs.

15. The outlet of claim 11, further comprising one or more light indicators for showing the condition of said noise filters, each indicator coupled to one of said noise filters.

16. The outlet of claim 11 wherein said noise isolating filters filter out electrical noise in the frequency range between 2 MHz and 34 MHz.

17. The outlet of claim 11 wherein said surge protectors comprise one or more metal oxide varistors.

18. A power-line communication network, comprising:
a. A system of interconnected power-lines for distributing alternating current power and for transmitting data; and,
b. A plurality of the outlets of claim 11, for filtering noise from and for connecting devices to the network, coupled to said interconnected power-lines.

19. A power-line communication network, comprising:
a. A system of interconnected power-lines for distributing alternating current power and for transmitting data; and,
b. A plurality of the outlets of claim 12, for filtering noise from and for connecting devices to the network, coupled to said interconnected power-lines.
